(19) United States
(12) Patent Application Publication
(10) Pub. No.: US 2014/0199575 A1
(43) Pub. Date: Jul. 17, 2014

(54) BATTERY PACK

(71) Applicant: SAMSUNG SDI CO., LTD., Yongin-si (KR)

(72) Inventor: Jae-Uk Ryu, Yongin-si (KR)

(73) Assignee: SAMSUNG SDI CO., LTD., Yongin-si (KR)

(21) Appl. No.: 14/139,804

(22) Filed: Dec. 23, 2013

(30) Foreign Application Priority Data
Jan. 15, 2013 (KR) 10-2013-0004229

(51) Int. Cl. H01M 2/10

(52) U.S. Cl. CPC H01M 2/1061
USPC 429/99

(57) ABSTRACT

A battery pack includes a frame member having a bottom surface and a side surface extending from the bottom surface, and having an opened top opposite to the bottom surface; at least one bare cell accommodated in the frame member; and an exterior member surrounding the bare cell and at least a portion of the frame member, wherein the exterior member is spaced from at least a portion of the side surface.

### CROSS-REFERENCE TO RELATED APPLICATION

This application claims priority to and the benefit of Korean Patent Application No. 10-2013-0004229, filed on Jan. 15, 2013, in the Korean Intellectual Property Office, the entire content of which is incorporated herein by reference.

### BACKGROUND

1. Field

An aspect of the present invention relates to a battery pack.

2. Description of the Related Art

Recently, as portable information devices such as cellular phones and mobile computers are required to be small in size and thin in thickness, secondary batteries that become power sources of the portable information devices are also required to be small in size and thin in thickness.

Accordingly, an exterior case of a battery pack is manufactured using a material having the thickness of a thin film, but it is difficult to manufacture the exterior case to have a certain thickness or less due to the problems of injection and safety. Thus, there has recently been developed a battery pack manufactured in such a manner that an exterior label is attached to a portion of an exterior case.

However, as the portion at which the exterior label is attached to the exterior case having the thickness of a thin film is frequently deformed, uncoupling of the exterior label from the case may occur, and therefore, a failure occurs in the exterior appearance of the battery pack.

### SUMMARY

Embodiments provide a battery pack capable of preventing deformation of its exterior appearance by applying a new structure to an exterior case accommodating battery cells therein and an exterior label attached to the exterior case.

According to an aspect of the present invention, there is provided a battery pack, including: a frame member having a bottom surface and a side surface bent to extend from the bottom surface, and having an opened top surface opposite to the bottom surface; at least one bare cell accommodated in the frame member through the opened top surface; and an exterior member surrounding the bare cell and at least one portion of the frame member, wherein the exterior member is spaced apart from at least one portion of the side surface.

At least one portion of the exterior member may include an adhesive layer.

The side surface may have a tapered structure in which the width of the side surface is narrowed as the side surface reaches from the bottom surface to the opened top surface of the frame member.

When the entire length of the side surface is 100%, the exterior member may be provided to surround 25% or more of the length of the side surface.

A groove may be formed in the side surface.

The at least one portion of the exterior member may be inserted into the groove.

An adhesive may be coated inside the groove.

The exterior member may include a first portion surrounding the opened top surface of the frame member, and a second portion surrounding the side surface while having a thickness thinner than that of the first portion.

When the entire thickness of the first portion is 100%, the thickness of the second portion may be no more than 50% of the thickness of the first portion.

The exterior member may include a first exterior member surrounding the opened top surface of the frame member and a portion of the side surface, and a second exterior member disposed on the first exterior member. The second exterior member may be disposed on the opened top surface of the frame member.

A reinforcing member may be further provided between the bare cell and the side surface.

As described above, according to the present invention, it is possible to provide a battery pack capable of preventing deformation of its exterior appearance by applying a new structure to an exterior case accommodating battery cells therein and an exterior label attached to the exterior case.

Further, according to the present invention, it is possible to provide a battery pack capable of improving process efficiency by reducing the failure rate of the exterior appearance thereof.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a battery pack according to an embodiment of the present invention.

FIG. 2 is an exploded perspective view of FIG. 1.

FIG. 3A is a partial perspective view of the battery pack according to a first embodiment of the present invention.

FIG. 3B is a sectional view taken along line A-A of FIG. 3A.

FIG. 3C is an enlarged view of a portion of FIG. 3B.

FIG. 4A is a partial perspective view of the battery pack according to a second embodiment of the present invention.

FIG. 4B is a sectional view taken along line B-B of FIG. 4A.

FIG. 5A is a partial perspective view of the battery pack according to a third embodiment of the present invention.

FIG. 5B is an enlarged view of a portion of FIG. 5A.

FIG. 6 is a partial perspective view of the battery pack according to a fourth embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on another element or be indirectly on another element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements. In the drawings, the thickness or size of layers are exaggerated for clarity and not necessarily drawn to scale.

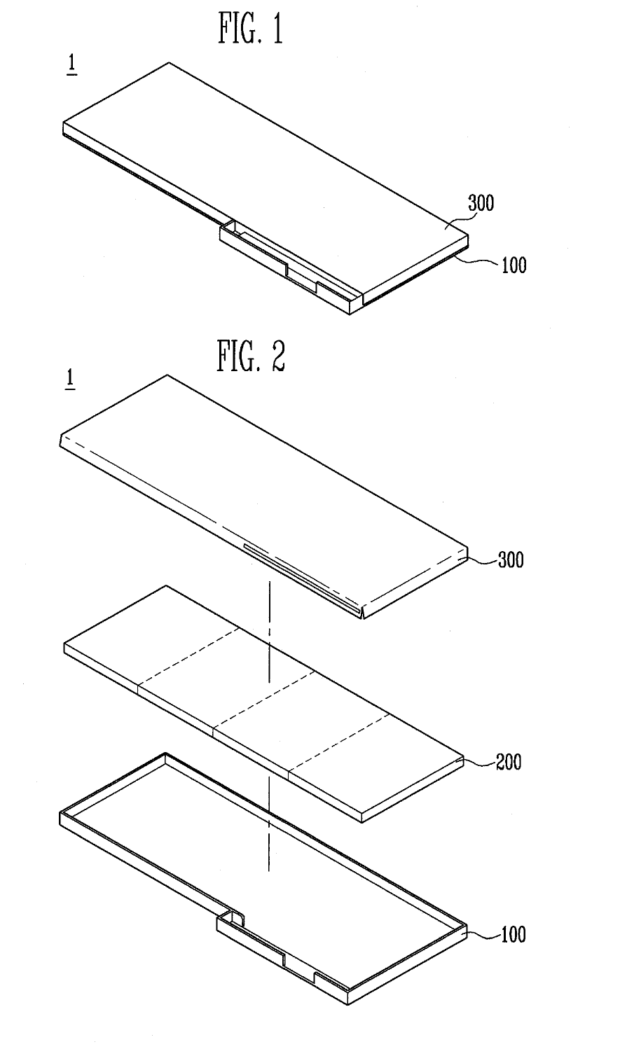

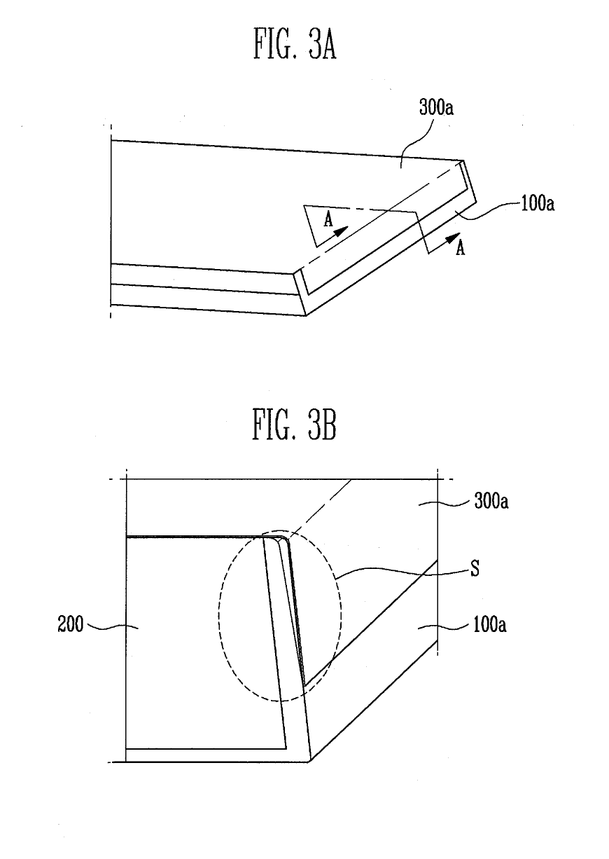

FIG. 1 is a perspective view of a battery pack according to an embodiment of the present invention. FIG. 2 is an exploded perspective view of FIG. 1. FIG. 3 is a perspective view of a bare cell provided in the battery pack according to the embodiment of the present invention. FIG. 3A is a partial perspective view of the battery pack according to the first embodiment of the present invention. FIG. 3B is a sectional view taken along line A-A of FIG. 3A. FIG. 3C is an enlarged view of a portion of FIG. 3B.

Referring to FIGS. 1, 2 and 3B, the battery pack 1 according to the present invention includes a frame member 100 having a bottom surface and a side surface 100a bent to extend from the bottom surface, and having an opened top surface opposite to the bottom surface, the opened top surface being defined at least in part by an edge of the side surface; at least one bare cell 200 accommodated in the frame member through the opened top surface; and an exterior member 300 surrounding the bare cell 200 and at least one portion of the frame member 100. The exterior member 300 is spaced from at least one portion of the side surface 100a.

The bare cell 200 may be a secondary battery that can be repetitively charged/discharged. For example, the bare cell 200 may be provided as a prismatic or pouch-type bare cell. The battery pack 1 according to this embodiment may include one or more bare cells 200. The bare cells 200 may be arranged in parallel so that short-side surfaces of adjacent bare cells 200 contact each other. However, the arrangement of the bare cells 200 may be variously modified according to the design of the battery pack 1, and the present invention is not limited thereto.

The exterior member 300 is attached to a portion of the frame member 100, and therefore, at least one portion of the exterior member 300 may include an adhesive layer.

Referring to FIGS. 3A to 3C, in the frame member 100 of the battery pack 1 according to the first embodiment, the side surface 100a has a tapered structure S in which the width of the side surface 100a is narrowed in a direction from the bottom surface to the opened top surface of the frame member 100. Thus, a spaced portion is formed between the side surface 100a of the frame member 100 and an exterior member 300a surrounding the opened top surface of the frame member 100 and the side surface 100a.

As described above, when the entire length of the side surface 100a is considered to be 100%, in one embodiment the length of the portion at which the exterior member 300a contacts the side surface 100a, except the spaced portion, is about 25% or more of the length of the side surface 100a. For example, when the entire length of the side surface 100a is about 8 mm, the length of the portion at which the exterior member 300a contacts the side surface 100a becomes at least about 2 mm. This is because when the length of the portion at which the exterior member 300a contacts the side surface 100a is less than 25% of the length of the side surface 100a, the junction between the exterior member 300a and the side surface 100a may be considerably weakened.

According to the first embodiment, although the frame member 100 may become deformed, the spaced portion between the exterior member 300a and the frame member 100 is secured in advance, so that it is possible to prevent the partial or entire unpeeling or uncoupling of the exterior member 300a after the exterior member 300a is attached to the frame member 100. Accordingly, the deformation of the exterior member 300a, which may irregularly and frequently occur is prevented in advance, so that it is possible to reduce re-processing caused by a failure of the exterior appearance of the battery pack and to decrease the failure rate of the battery pack.

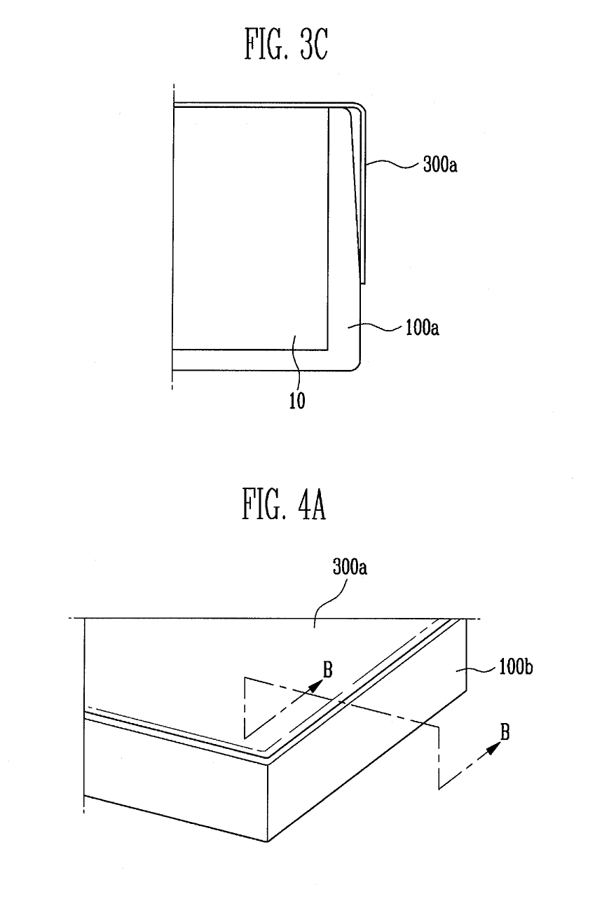

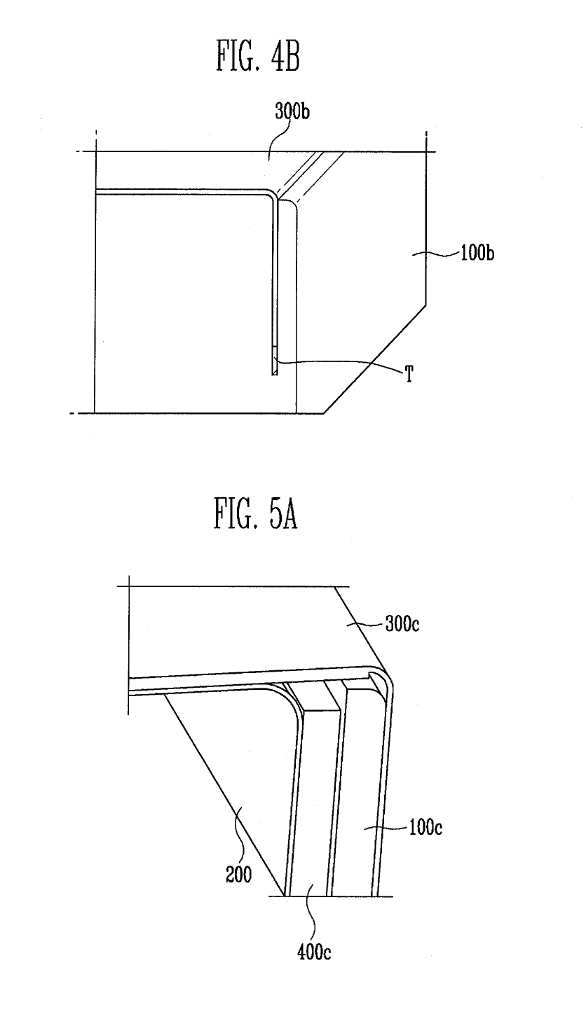

FIG. 4A is a partial perspective view of the battery pack according to a second embodiment of the present invention. FIG. 4B is a sectional view taken along line B-B of FIG. 4A.

Referring to FIGS. 4A and 4B, a groove T is formed in a side surface 100b, and a portion of an exterior member 300b according to the second embodiment is inserted into the groove T formed in the side surface 100b. In one embodiment, an adhesive is coated inside the groove T formed in the side surface 100b. The adhesive may be coated before or after the exterior member 300b is inserted into the groove T. The entire length of the side surface 100b is a few millimeters (mm), and therefore, the groove T has a considerably narrow and long structure. In one embodiment, the adhesive coated inside the groove T has a liquid form, and is injected into the groove T by an injection means such as a syringe.

According to the second embodiment, the exterior member 300b is adhered to the side surface 100b by being physically inserted into the groove T formed in the side surface 100b, so that it is possible to prevent, in advance, a problem in that the exterior member 300b attached to the narrow side surface 100b is deformed by being pulled to the opened top surface of the wide frame member 300b. Accordingly, the deformation of the exterior member 300b, which may irregularly and frequently occur is prevented in advance, so that it is possible to reduce re-processing caused by a failure of the exterior appearance of the battery pack and to decrease the failure rate of the battery pack.

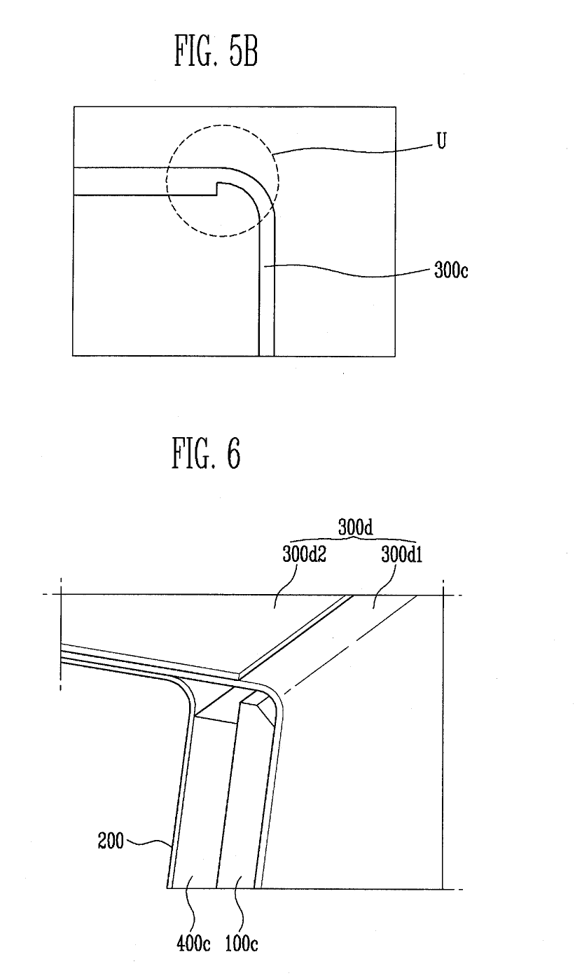

FIG. 5A is a partial perspective view of the battery pack according to a third embodiment of the present invention. FIG. 5B is an enlarged view of a portion of FIG. 5A.

Referring to FIGS. 5A and 5B, an exterior member 300c according to the third embodiment has a structure U in which the thickness of the exterior member 300c is partially changed. Specifically, the exterior member 300c includes a first portion surrounding the opened top surface of the frame member 100, and a second portion surrounding a side surface 100c while having a thickness thinner than a thickness of the first portion. When the entire thickness of the first portion is 100%, the thickness of the second portion is, for example, 50% of the thickness of the first portion or less. In a case where the thickness of the second portion becomes 50% or more of the entire thickness of the first portion, the difference in thickness between the first and second portions is decreased so that the second portion is pulled to the opened top surface of the frame member, wherein the exterior member 300c may be deformed.

According to the third embodiment, the structure U having partially different thicknesses is applied to the exterior member 300c, so that it is possible to prevent, in advance, a problem in that the exterior member 300c attached to the narrow side surface 100c is deformed by being pulled to the opened top surface of the wide frame member 300c. Accordingly, the deformation of the exterior member 300c, which may irregularly and frequently occur is prevented in advance, so that it is possible to reduce re-processing caused by a failure of the exterior appearance of the battery pack and to decrease the failure rate of the battery pack.

In one embodiment, a reinforcing member 400c may be further provided between the bare cell 200 and the side surface 100c in order to further improve the effect of preventing the deformation of the exterior member 300c having different thicknesses and to protect the bare cell 200 from the thin side surface 100c.

FIG. 6 is a partial perspective view of the battery pack according to a fourth embodiment of the present invention.

Referring to FIG. 6, an exterior member 300d according to the fourth embodiment has a double structure. Specifically, the exterior member 300d includes a first exterior member 300d1 surrounding the opened top surface of the frame member 100 and a portion of a side surface 100c, and a second exterior member 300d2 located on the first exterior member 300d1. In one embodiment, the second exterior member 300d2 is located on the opened top surface of the frame member 100.

According to the fourth embodiment, the double structure is applied so that the thickness of the exterior member 300c is partially changed, i.e., the thickness is varied along its length. Thus, it is possible to prevent, in advance, a problem in that the exterior member 300c attached to the narrow side surface 100c is deformed by being pulled to the opened top surface of the wide frame member 300c. Accordingly, the deformation of the exterior member 300c, which may irregularly and frequently occur is prevented in advance, so that it is possible to reduce re-processing caused by a failure of the exterior appearance of the battery pack and to decrease the failure rate of the battery pack.

In one embodiment, a reinforcing member 400c may be further provided between the bare cell 200 and the side surface 100c in order to further improve the effect of preventing the deformation of the exterior member 300d having different thicknesses and to protect the bare cell 200 from the thin side surface 100d.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery pack, comprising:
a frame member having a bottom surface and a side surface extending from the bottom surface, and having an opened top opposite to the bottom surface;
at least one bare cell accommodated in the frame member; and
an exterior member surrounding the bare cell and at least a portion of the frame member,
wherein the exterior member is spaced from at least a portion of the side surface.

2. The battery pack of claim 1, wherein at least a portion of the exterior member includes an adhesive layer.

3. The battery pack of claim 1, wherein the side surface has a tapered structure in which a width of the side surface is narrowed in a direction away from the bottom surface to the opened top of the frame member.

4. The battery pack of claim 1, wherein the exterior member surrounds about 25% or more of a length of the side surface.

5. The battery pack of claim 1, wherein a groove is located in the side surface.

6. The battery pack of claim 5, wherein the at least one portion of the exterior member is located in the groove.

7. The battery pack of claim 5, wherein an adhesive is coated inside the groove.

8. The battery pack of claim 1, wherein the exterior member includes a first portion surrounding the opened top of the frame member, and a second portion surrounding the side surface, the second portion having a thickness less than a thickness of the first portion.

9. The battery pack of claim 8, wherein the thickness of the second portion is not more than about 50% of the thickness of the first portion.

10. The battery pack of claim 1, wherein the exterior member includes a first exterior member surrounding the opened top surface of the frame member and a portion of the side surface, and a second exterior member located on the first exterior member, and
wherein the second exterior member is located on the opened top of the frame member.

11. The battery pack of claim 1, further comprising a reinforcing member located between the bare cell and the side surface of the frame member.
